(19) United States
(12) Patent Application Publication
(10) Pub. No.: US 2013/0215497 A1
(43) Pub. Date: Aug. 22, 2013

(54) SCREEN PROTECTOR

(71) Applicants: SHENG-CHIEN CHAN, TAOYUAN COUNTY (TW); CHERNG-WEN YU, TAOYUAN COUNTY (TW)

(72) Inventors: SHENG-CHIEN CHAN, TAOYUAN COUNTY (TW); CHERNG-WEN YU, TAOYUAN COUNTY (TW)

(73) Assignee: YUXI TECHNOLOGY CO., LTD., TAOYUAN COUNTY (TW)

(21) Appl. No.: 13/480,890

(22) Filed: May 25, 2012

(30) Foreign Application Priority Data
Feb. 21, 2012 (TW) 101203132

(51) Int. Cl. G02B 1/11

(52) U.S. Cl. 359/350; 359/601

(57) ABSTRACT

A screen protector is revealed. The screen protector includes a first microstructure layer, a transparent protective layer, a second microstructure layer, a plurality of ink layer, and a silicone layer. The transparent protective layer is disposed over the first microstructure layer and the second microstructure layer is arranged over the transparent protective layer. The ink layers are stacked in a frame form and disposed over the second microstructure layer. The silicone layer is also a frame arranged over the ink layers. The screen protector provides high anti-glare and anti-reflective effect by the arrangement of the first microstructure layer and the second microstructure layer. Moreover, the screen protector is applied conveniently due to disposition of the ink layers and the silicone layer.

### BACKGROUND OF THE INVENTION

1. Fields of the invention

The present invention relates to a protector, especially to a screen protector with properties of anti-glare and anti-reflection for better visual effect.

2. Descriptions of Related Art

With the fast development of technology, electronic devise available now generally include a display screen for performing/displaying an operation state of the device. However, a liquid crystal screen generally gets scratched easily. Thus a screen surface is applied with a screen protector to prevent the screen from getting scratched. The screen protector has been widely used in electronic devices such as mobile phones, cameras or portable multimedia players. Most of screen protectors are in a single-layer structure made from transparent plastic material. The bottom of the single layer structure includes an adhesive layer covered with a piece of release film. While applying the screen protector, peel the release film off and then attach the screen protector to the screen by the adhesive layer.

While being used for outdoor applications in daylight, LCD screens of electronic devices are difficult to see clearly due to reflection. Besides reduced visibility and blurred images, users' eyes are tired and reading becomes difficult. Other physical signs include eye strains and headaches. Thus anti-reflection protection and anti-glare protection become quite important.

Moreover, if the screen protector is not laying flat during application of the screen protector, air bubbles are left between the screen and the screen protector. Then use a tool to carefully remove all the air bubbles. When there are air bubbles you can't get out, pull up a part of the screen protector without removing it fully and post again. The screen protector applied smoothly with no bubbles is used to protect the screen from dust and scratches. Furthermore, the screen protector might not go on smoothly, with wrinkles trapped. Peel the screen protector off and try again. The process is inconvenient and troublesome.

Refer to Taiwanese Pub. App. No. 586533, a protective adhesive film mainly includes a release film, a protective film and a transfer film. The release film consists of a release substrate and a release adhesive while the protective film is formed by a protective substrate and a protective adhesive. While in use, the protective adhesive film has the problems of bubbles or wrinkles mentioned above. Thus users need to remove the screen protector and apply it again. Moreover, problems of reflection and glare still exist.

Thus there is room for improvement and a need to provide a novel screen protector that solves the above shortcomings and having features of anti-glare, anti-reflection, higher convenience and safety. Moreover, the new screen protector protects users from infections spread by electronic devices.

### SUMMARY OF THE INVENTION

Therefore it is a primary object of the present invention to provide a screen protector in which high anti-glare and anti-reflective effect is obtained by disposition a first microstructure layer and a second microstructure layer.

It is another object of the present invention to provide a screen protector that is easy and convenient to install due to arrangement of a plurality of ink layers.

It is a further object of the present invention to provide a screen protector with an anti-microbial layer to keep users safe during use.

It is a further object of the present invention to provide a screen protector that is disposed with microstructures for anti-peel, anti-glare, light scattering and light-conducting for brightness enhancement, or decoration

In order to achieve the above objects, a screen protector of the present invention includes a first microstructure layer, a transparent protective layer, a second microstructure layer, a plurality of ink layer, and a silicone layer. The transparent protective layer is arranged over the first microstructure layer and the second microstructure layer is disposed over the transparent protective layer. The ink layers are stacked in a frame form and disposed around a top surface of the second microstructure layer. The silicone layer is also in a form of a frame and is arranged over the ink layers.

In order to achieve the above objects, a screen protector of the present invention includes a first microstructure layer, a transparent protective layer, a second microstructure layer, and a silicone layer. The transparent protective layer is set over the first microstructure layer and the second microstructure layer is arranged over the transparent protective layer. The silicone layer is in a frame form disposed over the second microstructure layer.

The screen protector further includes an anti-microbial layer which is disposed over the first microstructure layer.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an enlarged cross sectional view of an embodiment according to the present invention;

FIG. 2 is an explosive view of the embodiment in FIG. 1;

FIG. 3A is a schematic drawing showing an embodiment in use according to the present invention;

FIG. 3B is another schematic drawing showing an embodiment in use according to the present invention;

FIG. 4 is an enlarged cross sectional view of another embodiment according to the present invention;

FIG. 5 is an enlarged cross sectional view of a first microstructure layer, a transparent protective layer and a second microstructure layer of a further embodiment according to the present invention; and

FIG. 6 is a partial enlarged of a further embodiment according to the present invention.

### p DETAILED DESCRIPTION OF THE PREFERRED EMBODIMENT

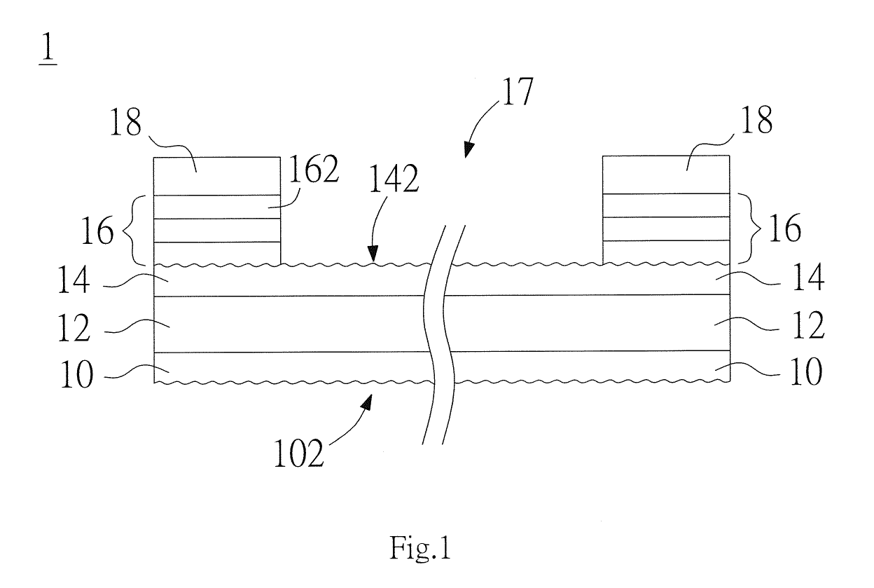

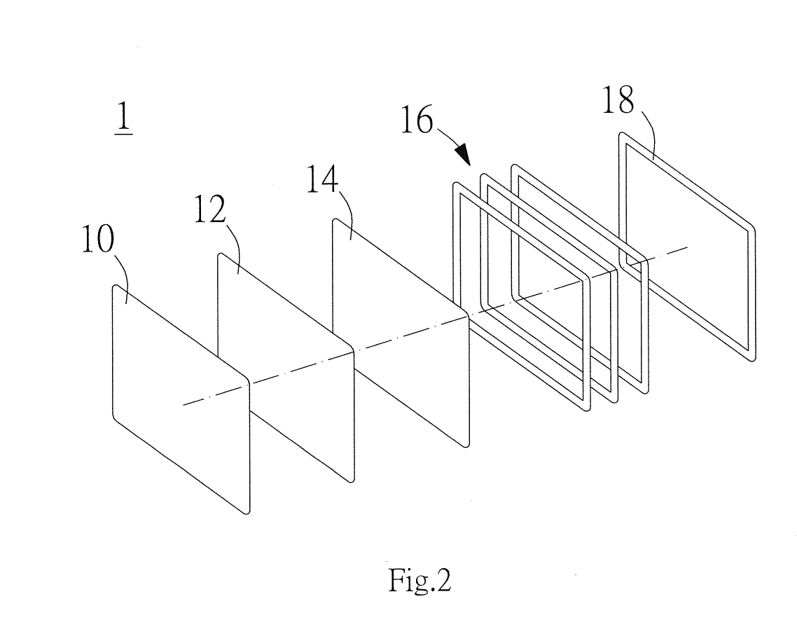

Refer to FIG. 1 and FIG. 2, a screen protector 1 includes a first microstructure layer 10, a transparent protective layer 12, a second microstructure layer 14, a plurality of ink layers 16, and a silicone layer 18. The transparent protective layer 12 is disposed over the first microstructure layer 10 and the second microstructure layer 14 is arranged over the transparent protective layer 12. Then the ink layers 16 are stacked over and arranged at edges on top of the second microstructure layer 14 by printing. The ink layers 16 are in a form of a frame or around a periphery on top of other layers. At last, the silicone layer 18 is disposed over the ink layer 16 by printing, also in the form of a frame or around the periphery on top of other layers.

The transparent protective layer 12 is a film made from transparent material, a plate made from flexible soft material, or a plate made from hard material (such as thin glass plate). Both the first microstructure layer 10 and the second microstructure layer 14 are made from transparent material. Thus the first microstructure layer 10, the transparent protective layer 12, and the second microstructure layer 14 allow light to pass through, without shading a screen of electronic devices. A lower surface 102 of the first microstructure layer 10 and an upper surface 142 of the second microstructure layer 14 are not flat but rough. When the electronic device with the screen protector 1 is used by users, the screen protector 1 is with high anti-glare and high anti-reflection properties due to rough surfaces of the first microstructure layer 10 and the second microstructure layer 14. Thus users' eyes will not become tired or feel uncomfortable easily. Moreover, the resolution is improved and the visual effect is better. The user can see the screen more clearly.

For providing various functions such as anti-glare, light scattering and light-conducting for brightness enhancement, or decoration, the rough surfaces of the first microstructure layer 10 and the second microstructure layer 14 having matte patterns, hemispheric patterns, patterns with right angled isosceles triangles, hair patterns, leather patterns, knitting patterns, carbon patterns or concentric circle patterns. Due to special design of the first microstructure layer 10 and the second microstructure layer 14, the screen is safeguarded for preventing unwanted peeking and spying. The screen protector offers a viewing angle ranges from 30 degrees to 100 degrees.

The first microstructure layer 10 and the second microstructure layer 14 are produced by following steps. Firstly, a resin layer (such as UV adhesive) is arranged at both sides of the transparent protective layer 12 by coating, imprinting or transfer printing. Then the transparent protective layer 12 is irradiated by ultraviolet (UV) light. Thus the first microstructure layer 10 and the second microstructure layer 14 are respectively formed on an upper surface and a lower surface of the transparent protective layer 12. The lower surface 102 of the first microstructure layer 10 and the upper surface 142 of the second microstructure layer 14 formed are rough so as to solve light reflection and glare problems.

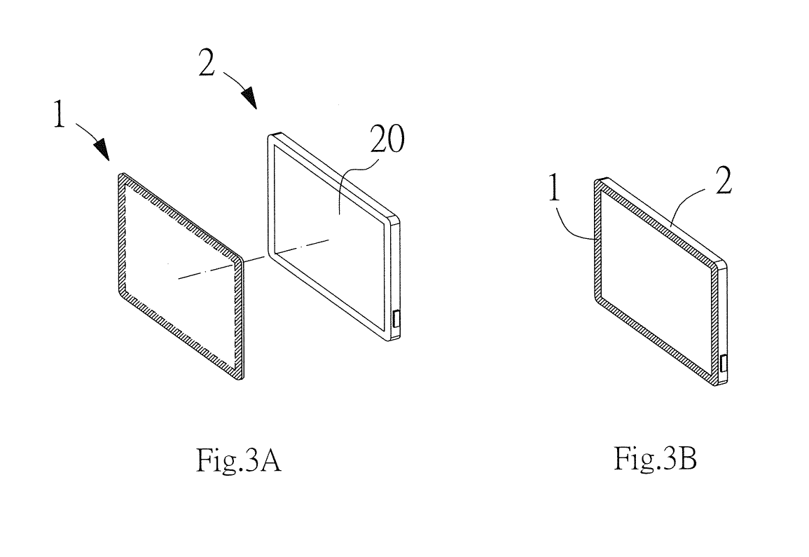

Moreover, refer to FIG. 1, FIG. 3A and FIG. 3B, the ink layers 16 are arranged over the second microstructure layer 14 by printing. The ink layers 16 include three or four layers of ink paintings 162. An interval space 17 is formed on a center of and enclosed by the ink layers 16 and the silicone layer 18. Generally the screen protector 1 is attached to a screen 20 of an electronic device 2. The interval space 17 prevents the second microstructure layer 14 from contacting with the screen 20 directly. Thus the screen protector 1 is applied without getting bubbles and wrinkles trapped during the process. The device is simple and convenient to use. The silicone layer 18 is set on the ink layers 16 also by printing. While applying the screen protector 1 to the electronic device 2, users can attach or remove the screen protector 1 easily and repeatedly because the silicone layer 18 is different from general adhesives.

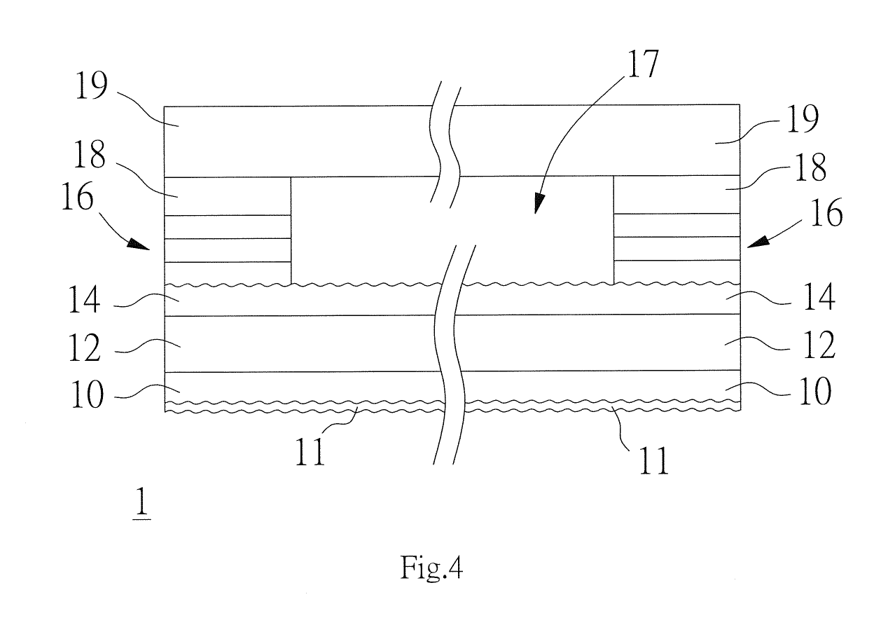

Refer to FIG. 4, a partial enlarged view of anther embodiment according to the present invention is revealed. The screen protector 1 further includes an anti-microbial layer 11 disposed on the first microstructure layer 10. The anti-microbial layer 11 is made from nano-scale silver (<40 nm) or other anti-microbial material that prevents residual Staphylococcus aureus, Escherichia coli, or other bacteria on the screen protector 1, The residual bacteria left on hands are minimized and the risk of infection is reduced. The anti-microbial layer 11 can be coated with a resin layer (not shown in figure) with high or low refractive index so as to increase the anti-refractive effect. The screen protector 1 further includes a piece of release paper 19. The release paper 19 is disposed over the silicone layer 18. The release paper 19 is used to prevent the silicone layer 18 from sticking to other objects while the screen protector 1 has not been used yet. The release paper 19 is also helpful for storage of the screen protector 1.

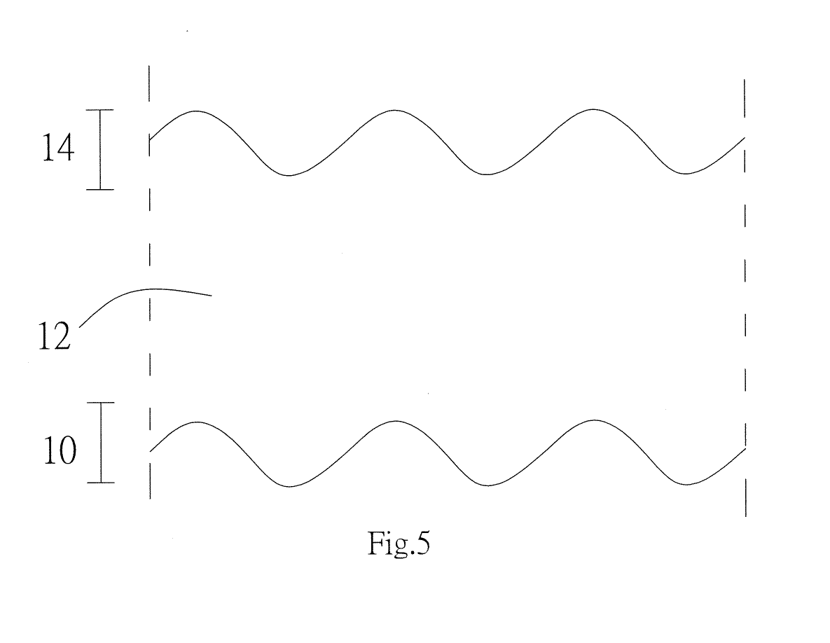

Refer to FIG. 5, a further embodiment is revealed. The formation of the first microstructure layer 10 and the second microstructure layer 14 in this embodiment is different from that in the above embodiment. The first microstructure layer 10 and the second microstructure layer 14 are respectively formed on two sides of the transparent protective layer 12 by embossing. Thus the two sides of the transparent protective layer 12 are both rough. Generally, the embossing technique is used when the transparent protective layer 12 is made from harder material. Once the transparent protective layer 12 is made from softer material (or thin film), the method mentioned in the first embodiment is used.

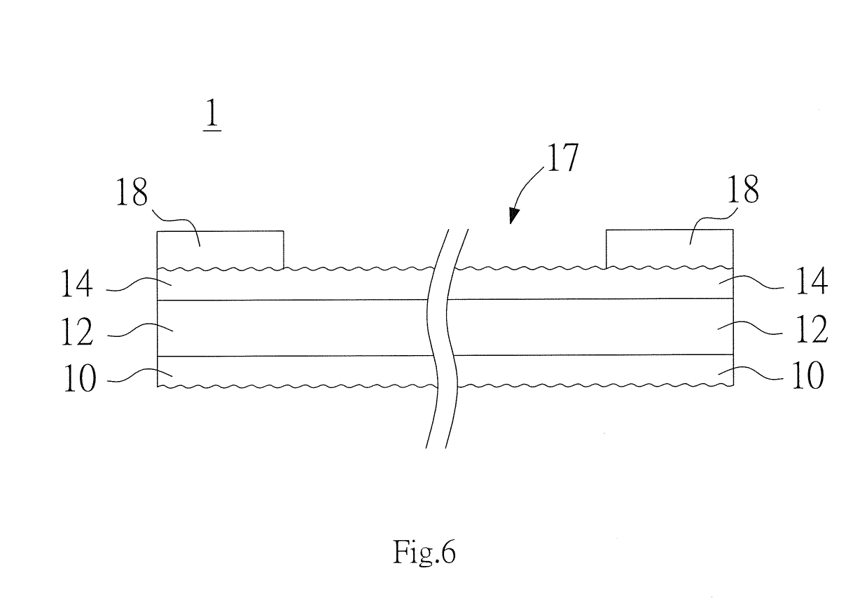

Refer to FIG. 6, a further embodiment is disclosed. The difference between this embodiment and the above ones is in that this embodiment includes no ink layers 16 (also refer to FIG. 1). As mentioned above, the interval space 17 keeps a certain distance (interval) between the second microstructure layer 14 and the screen 20, as shown in FIG. 3A. The ink layers 16 can be replaced by the disposition of the silicone layer 18 with larger thickness. Furthermore, the structure and the function of the first microstructure layer 10 and the second microstructure layer 14 in this embodiment are the same with those of the first embodiment. This embodiment can also be arranged with the anti-microbial layer 11 and the release paper (as shown in FIG. 4).

In summary, the screen protector provides high anti-glare and anti-reflective effect by the disposition of the first microstructure layer and the second microstructure layer. Moreover, the problems of bubbles and wrinkles during the attachment of the screen protector are solved by the arrangement of the ink layers and the silicone layer. Thus the screen protector is applied more easily and conveniently.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A screen protector comprising:
a first microstructure layer;
a protective layer that is disposed over the first microstructure layer;
a second microstructure layer that is arranged over the transparent protective layer;
a plurality of ink layers stacked on top of each other and all arranged around a periphery on top of the second microstructure; and
a silicone layer disposed around a periphery on top of the ink layers.

2. The device as claimed in claim 1, wherein a lower surface of the first microstructure layer and an upper surface of the second microstructure layer are rough surfaces formed by a resin layer being coated on both sides of the transparent protective layer and cured by ultraviolet (UV) light irradiation.

3. The device as claimed in claim 1, wherein the first microstructure layer and the second microstructure layer are formed on two sides of the transparent protective layer by embossing so that the two sides of the transparent protective layer are both rough.

4. The device as claimed in claim 1, wherein the screen protector further includes an anti-microbial layer which is disposed over the first microstructure layer.

5. The device as claimed in claim 4, wherein the anti-microbial layer is coated with a resin layer having high or low refractive index for improving anti-refractive effect of the screen protector.

6. The device as claimed in claim 1, wherein the ink layers are three ink layers or four ink layers.

7. The device as claimed in claim 1, wherein an interval space is formed on a center of the ink layers and the silicone layer; the silicone layer is disposed over the ink layers by printing.

8. The device as claimed in claim 1, wherein the transparent protective layer is a film made from transparent material, a plate made from flexible soft material, or a plate made from hard material.

9. The device as claimed in claim 1, wherein a piece of release paper is covered over the silicone layer.

10. The device as claimed in claim 1, wherein the first microstructure layer and the second microstructure layer having matte patterns, hemispheric patterns, patterns with right angled isosceles triangles, hair patterns, leather patterns, knitting patterns, carbon patterns or concentric circle patterns.

11. A screen protector comprising:
a first microstructure layer;
a protective layer that is disposed over the first microstructure layer;
a second microstructure layer that is arranged over the transparent protective layer; and
a silicone layer disposed around a periphery on top of the second microstructure layer.

12. The device as claimed in claim 11, wherein a lower surface of the first microstructure layer and an upper surface of the second microstructure layer are rough surfaces formed by a resin layer being coated on both sides of the transparent protective layer and cured by ultraviolet (UV) light irradiation.

13. The device as claimed in claim 11, wherein the first microstructure layer and the second microstructure layer are formed on two sides of the transparent protective layer by embossing so that the two sides of the transparent protective layer are both rough.

14. The device as claimed in claim 11, wherein the screen protector further includes an anti-microbial layer which is disposed over the first microstructure layer.

15. The device as claimed in claim 14, wherein the anti-microbial layer is coated with a resin layer having high or low refractive index for improving anti-refractive effect of the screen protector

16. The device as claimed in claim 11, wherein the ink layers are three ink layers or four ink layers.

17. The device as claimed in claim 11, wherein a piece of release paper is covered over the silicone layer

18. The device as claimed in claim 11, wherein an interval space is formed on a center of the silicone layer.

19. The device as claimed in claim 11, wherein the transparent protective layer is a film made from transparent material, a plate made from flexible soft material, or a plate made from hard material.

20. The device as claimed in claim 11, wherein the first microstructure layer and the second microstructure layer having matte patterns, hemispheric patterns, patterns with right angled isosceles triangles, hair patterns, leather patterns, knitting patterns, carbon patterns or concentric circle patterns.
